(19) United States
(12) Patent Application Publication
(10) Pub. No.: US 2012/0179899 A1
(43) Pub. Date: Jul. 12, 2012

(54) UPGRADEABLE PROCESSOR ENABLING HARDWARE LICENSING

(75) Inventors: Paul E. Schardt, Rochester, MN (US); Robert A. Shearer, Rochester, MN (US)

(73) Assignee: International Business Machines Corporation, Armonk, NY (US)

(21) Appl. No.: 12/986,660

(22) Filed: Jan. 7, 2011

(51) Int. Cl. G06F 9/00

(52) U.S. Cl. 713/2

(57) ABSTRACT

A technique for programming a configurable co-processor in a processing system is disclosed. The configurable co-processor includes field programmable logic and is configured using a pre-generated co-processor image. The technique involves enabling a user application to program the configurable co-processor with certain application-specific hardware based processing functions. One advantage of the present invention is that application-specific hardware design optimizations may be implemented to improve application performance after hardware for the processing system has been manufactured.

### BACKGROUND

The field of the present invention relates to configurable logic in general, and, more specifically, to an upgradeable processor enabling hardware licensing.

Data processing systems such as computers, workstations, servers and game consoles typically comprise processing units configured to execute a fixed instruction set, with fixed on-chip buffering and caching capacities. In such systems, on-chip buffers and caches need to be sized to accommodate a wide variety of potential known workloads using the fixed instruction set. Furthermore, the instruction set must be specified to efficiently accommodate the known workloads. In many scenarios, however, future workloads are not known when the processing units are designed, resulting in significant anticipatory over-design. Such over-design increases system cost and may not necessarily satisfy actual future requirements.

As new applications are developed, corresponding new workloads need to be mapped onto existing processing units. In certain scenarios, existing processing units may include insufficient on-chip buffering or caching to efficiently execute the new workloads. Furthermore, new algorithms associated with the new applications may require new instructions or specialized computational resources that are not available in the existing processing units in order to execute efficiently.

In the above scenarios, existing processing units are not well suited to executing certain future workloads. When those workloads become available, users are typically forced to upgrade their entire data processing system in order to accommodate the new workloads. Such upgrades are disruptive and costly. As the foregoing illustrates, what is needed in the art is a technique for efficiently accommodating new, unspecified workloads using existing data processing systems.

### SUMMARY

The present invention generally includes a system, article of manufacture and method for programming a configurable co-processor. The method comprises selecting a co-processor image having characteristics that satisfy a specific set of processing requirements and comprising detailed instructions for configuring one or more logic circuits within the configurable co-processor, storing the co-processor image in a memory; programming the configurable co-processor based on the co-processor image stored in memory, and booting the configurable co-processor.

One advantage of the present invention is that application-specific hardware design optimizations may be implemented after hardware for a processing system has been manufactured. Application developers are able to develop new instruction sets or optimize parametrically defined processor systems based on application needs. This is advantageous compared to prior art systems in which all hardware design decisions are frozen prior to manufacture.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 depicts a computer system, configured to implement one or more aspects of the present invention.

FIG. 2 illustrates a configurable co-processor within the computer system, according to one embodiment of the present invention.

FIG. 3 illustrates an application architecture for transmitting different co-processor images to the configurable co-processor, according to an embodiment of the present invention.

FIG. 4 is a flow diagram of method steps for programming a configurable co-processor, according to one embodiment of the present invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

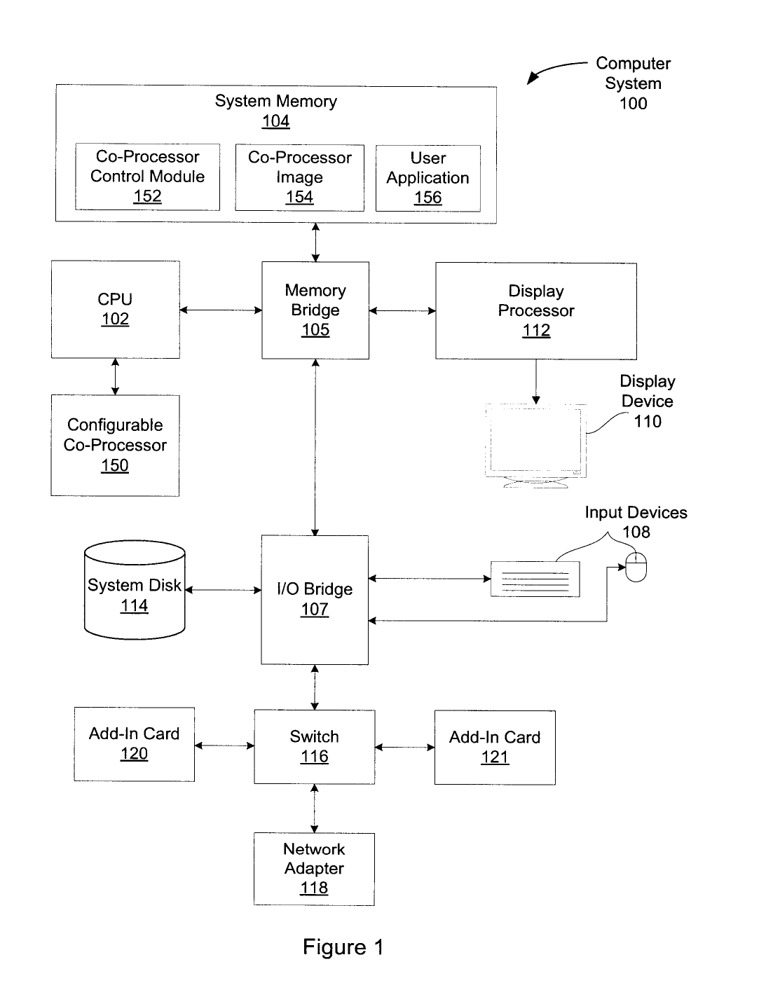

FIG. 1 is a block diagram of a computer system 100 configured to implement one or more aspects of the present invention. The system architecture depicted in FIG. 1 in no way limits or is intended to limit the scope of the present invention. Computer system 100 may be a computer workstation, personal computer, video game console, personal digital assistant, rendering engine, or any other device suitable for practicing one or more embodiments of the present invention.

As shown, computer system 100 includes a central processing unit (CPU) 102 and a system memory 104 communicating via a bus path that may include a memory bridge 105. CPU 102 includes one or more processing cores, and, in operation, CPU 102 controls and coordinates operations of other system components. System memory 104 stores software applications and data for use by CPU 102. CPU 102 runs software applications and optionally an operating system. Memory bridge 105, which may be, for example, a Northbridge chip, is connected via a bus or other communication path (e.g., a HyperTransport link) to an I/O (input/output) bridge 107. I/O bridge 107, which may be, for example, a Southbridge chip, receives user input from one or more user input devices 108 (e.g., keyboard, mouse, joystick, digitizer tablets, touch pads, touch screens, still or video cameras, motion sensors, and/or microphones) and forwards the input to CPU 102 via memory bridge 105.

A display processor 112 is coupled to memory bridge 105 via a bus or other communication path (e.g., a PCI Express, Accelerated Graphics Port, or HyperTransport link); in one embodiment display processor 112 is a graphics subsystem that includes at least one graphics engine and graphics memory. Graphics memory includes a display memory (e.g., a frame buffer) used for storing pixel data for each pixel of an output image. Graphics memory can be integrated in the same device as the graphics engine, connected as a separate device with the graphics engine, and/or implemented within system memory 104.

Display processor 112 periodically delivers pixels to a display device 110 (e.g., a screen or conventional CRT, plasma, OLED, SED or LCD based monitor or television) via a video signal. Additionally, display processor 112 may output pixels to film recorders adapted to reproduce computer generated images on photographic film. Display processor 112 can provide display device 110 with an analog or digital video signal.

A system disk 114 is also connected to I/O bridge 107 and may be configured to store content and applications and data for use by CPU 102 and display processor 112. System disk 114 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 116 provides connections between I/O bridge 107 and other components such as a network adapter 118 and various add-in cards 120 and 121. Network adapter 118 allows computer system 100 to communicate with other systems via an electronic communications network, and may include wired or wireless communication over local area networks and wide area networks such as the Internet.

Other components (not shown), including USB or other port connections, film recording devices, and the like, may also be connected to I/O bridge 107. For example, an audio processor may be used to generate analog or digital audio output from instructions and/or data provided by CPU 102, system memory 104, or system disk 114. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 112 incorporates circuitry optimized for graphics and video processing, including, for example, video output circuitry, and constitutes a graphics processing unit (GPU). In another embodiment, display processor 112 may be integrated with one or more other system elements, such as the memory bridge 105, CPU 102, and I/O bridge 107 to form a system on chip (SoC). In still further embodiments, display processor 112 is omitted and software executed by CPU 102 performs the functions of display processor 112.

Pixel data can be provided to display processor 112 directly from CPU 102. In some embodiments of the present invention, instructions and/or data representing a scene are provided to a render farm or a set of server computers, each similar to computer system 100, via network adapter 118 or system disk 114. The render farm generates one or more rendered images of the scene using the provided instructions and/or data. These rendered images may be stored on computer-readable media in a digital format and optionally returned to computer system 100 for display. Similarly, stereo image pairs processed by display processor 112 may be output to other systems for display, stored in system disk 114, or stored on computer-readable media in a digital format.

Alternatively, CPU 102 provides display processor 112 with data and/or instructions defining the desired output images, from which display processor 112 generates the pixel data of one or more output images, including characterizing and/or adjusting the offset between stereo image pairs. The data and/or instructions defining the desired output images can be stored in system memory 104 or graphics memory within display processor 112. In one embodiment, display processor 112 includes 3D rendering capabilities for generating pixel data for output images from instructions and data defining the geometry, lighting shading, texturing, motion, and/or camera parameters for a scene. Display processor 112 can further include one or more programmable execution units capable of executing shader programs, tone mapping programs, and the like.

It will be appreciated that the system shown herein is illustrative and that variations and modifications are possible. The connection topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies display processor 112 is connected to I/O bridge 107 or directly to CPU 102, rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

A configurable co-processor 150 is coupled to the CPU 102. The configurable co-processor 150 may be coupled to the CPU 102 via an auxiliary processor port, the memory bridge 105, or any other technically feasible system element. The configurable co-processor 150 comprises field programmable logic elements, such as Boolean evaluation elements and memory elements. The configurable co-processor 150 also comprises signal routing resources for connecting the field programmable logic elements together to form data processing circuits. The field programmable logic elements are programmed to assume a specific functional configuration when a co-processor image 154 is written to the configurable co-processor 150. The functional configuration may define, for example, logic circuits comprising a plurality of processing units configured to perform computational tasks. A given co-processor image 154 may program every configurable element within the configurable co-processor 150, or only program a certain subset of configurable elements within the configurable co-processor 150.

Persons skilled in the art will understand that any type of field programmable logic technology may be used to implement the configurable co-processor 150 without departing the scope and spirit of the present invention. In one embodiment, the configurable co-processor 150 comprises at least one field programmable gate array (FPGA), configured to be programmed by the CPU 102. The configurable co-processor 150 may be programmed, and reprogrammed during normal operation of the computer system 100. As such, the configurable co-processor 150 may assume different specific functional configurations, according to prevailing requirements of a user application 156.

The user application 156 is configured to perform certain computational tasks that may be implemented within the configurable co-processor 150. In one embodiment, a user may configure the user application 156 to perform the computational tasks via CPU 102 or via the configurable co-processor 150. In other embodiments, the user application 156 may require the computational tasks be performed on the configurable co-processor 150. A co-processor control module 152 is configured to program the configurable co-processor 150 using the co-processor image 154. In one embodiment, the co-processor image 154 is licensed and distributed for use on the computer system 100 in conjunction with a license for the user application 156. In other embodiments, the co-processor image 154 is licensed and distributed for use separately from the user application 156. Any technically feasible technique may be used to notify the user application 156 that a particular co-processor image 154 has been programmed into the configurable co-processor 150, thereby enabling the configurable co-processor 150 to perform specific computational tasks required by the user application 156.

Computer system 100 may be described in a general context of a computer system with executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

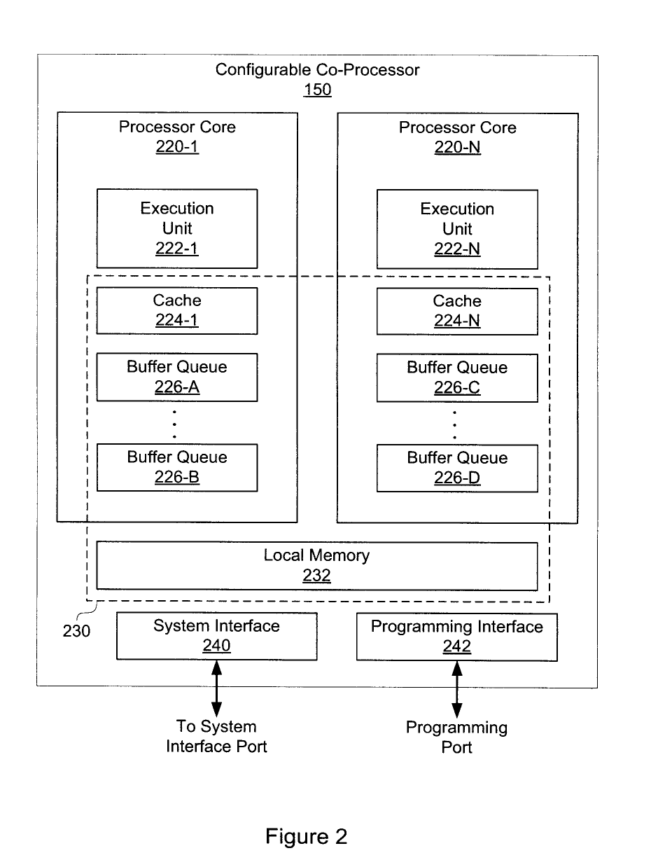

FIG. 2 illustrates configurable co-processor 150 within the computer system 100, according to one embodiment of the present invention. The configurable co-processor 150 includes a system interface 240, and one or more processor cores 220. The system interface 240 is coupled to a system interface port within the computer system 100, such as an auxiliary processor port associated with the CPU 102. The system interface 240 is configured to enable processor cores 220 to access data stored within system memory 104, and may enable the CPU 102 to access mapped registers within the configurable co-processor 150. Persons skilled in the art will understand that the system interface 240 may be implemented using any technically feasible techniques without departing the scope and spirit of the present invention.

A programming interface 242 is configured to receive data comprising the co-processor image 154, and to program the configurable co-processor 150 to assume a specific functional configuration based on the co-processor image 154. In one embodiment, the system interface port and programming port comprise physically separate ports. In an alternative embodiment, the system interface port and programming port comprise the same physical port on the CPU 102 or memory bridge 105.

The configurable co-processor 150 may include certain fixed function logic, such as the programming interface 242, which is needed to program the configurable circuits within the configurable co-processor 150. In one embodiment, the programming interface 242 comprises fixed function logic, and is configured to determine whether the configurable co-processor 150 is authorized to receive a particular co-processor image 154. Certain co-processor images 154 may require a usage license. Authorization may be implemented using any technically feasible technique. For example, a license key may be provided in conjunction with a particular co-processor image 154. If the license key is validated by the programming interface 242, then the co-processor image 154 may be programmed into the configurable co-processor 150.

In alternative embodiments, the programming interface 242 does not determine whether a particular co-processor image 154 is authorized. Instead, the co-processor image 154 includes functionality that, when programmed into the configurable co-processor 150, determines whether the co-processor image 154 is authorized for the particular configurable co-processor 150. For example, a license key may be presented to a freshly programmed configurable co-processor 150, which then determines whether the license key genuinely authorizes use of the co-processor image 154. In this example, the newly programmed functionality of the configurable co-processor 150 includes functions for determining whether the license key is valid. Persons skilled in the art will understand that various authorization and licensing techniques may be used without departing the scope and spirit of the invention.

In one embodiment, each processor core 220 includes an execution unit 222, configured to execute programming instructions stored in a memory, such as local memory 232, or system memory 104. A cache unit 222 may be configured to store certain programming instructions, certain program data, or any combination thereof. A set of buffer queues 226 may be configured to buffer a data stream. For example, buffer queues 226 may act as elasticity buffers for media data streams. The caches 222, buffer queues 226, and local memory 232 are configured from on-chip memory resources 230. The on-chip memory resources 230 represent a finite number of storage bits for forming all on-chip memory structures, such as the caches 222, buffer queues 226, and local memory 232. The on-chip memory structures need to be sized, in total, according to a total budget determined by the on-chip memory resources 230. Increasing the size of one on-chip memory structure generally reduces the number of bits available to other on-chip memory structures.

In certain applications, a larger cache 224 is more important to system performance than total storage in buffer queues 226. Such applications would, therefore, program the configurable co-processor 150 with a co-processor image 154 that specifies larger caches 224. In other applications, system performance is predominately determined by total storage in the buffer queues 226. These applications would, therefore, program the configurable co-processor 150 with a co-processor image 154 that specifies larger buffer queues 226. In yet other applications, the execution unit 222 may be configured to execute application-specific instructions to facilitate efficient performance of certain computational tasks. Programming the configurable co-processor 150, therefore, comprises both configuring the underlying logic elements within the configurable co-processor 150, and specifying a computational task via programming instructions, configuration settings, or any other technically feasible means. Programming the configurable co-processor 150 advantageously enables application-specific optimization via detailed allocation of underlying logic resources, whereas prior art processing systems only accommodate an a priori allocation of underlying logic resources, which can lead to lower overall performance for certain applications.

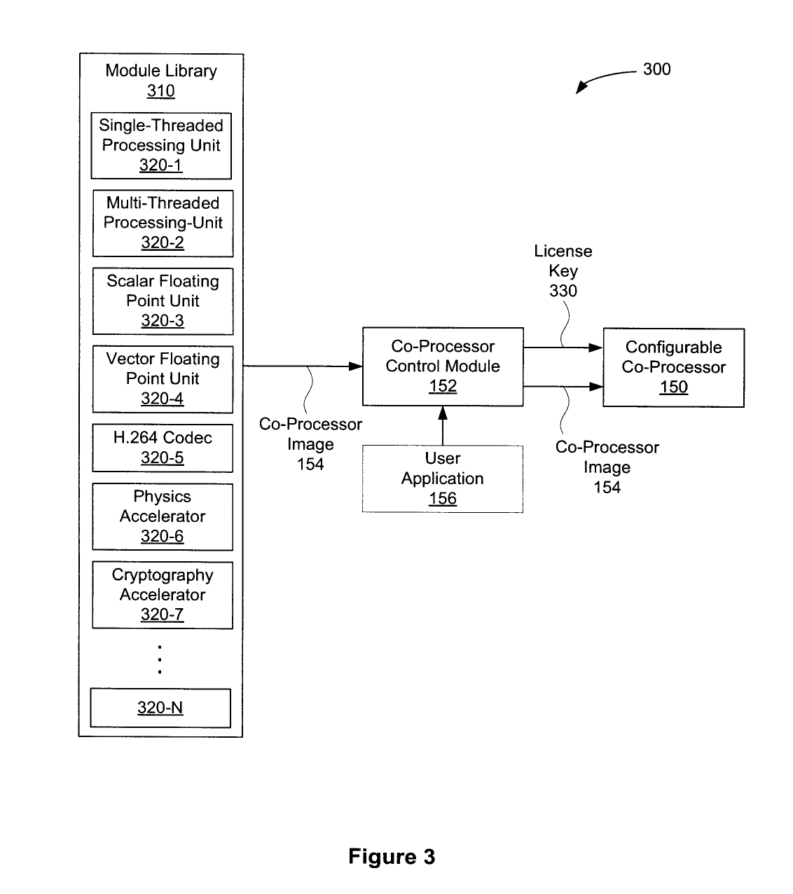

FIG. 3 illustrates an application architecture 300 for transmitting different co-processor images 320 to the configurable co-processor 150, according to an embodiment of the present invention. The different co-processor images 320 reside within a module library 310. Other module libraries (not show) may be configured to store other co-processor images, duplicates of the co-processor images 320, or any combination thereof. Each co-processor image 320 comprises a specific functional unit or units. For example, co-processor image 320-1 is a single-threaded processing unit, and co-processor image 320-7 is a cryptography accelerator.

In an exemplary runtime scenario, user application 156 requests a specific functionality for the configurable co-processor 150. The functionality, such as a specific physics accelerator function embodied in physics accelerator 320-6, is programmed into configurable co-processor 150 via the co-processor control module 152. In this example, physics accelerator 320-6 comprises co-processor image 154.

A specific module 320 within the module library 310 may require a usage license. The usage license may accompany the user application 156, or the usage license may be acquired separately. A license key 330 is used to indicate that the co-processor image 154 is permitted to be used with the configurable co-processor 150. As discussed previously in FIG. 2, the license key 330 is used by the configurable co-processor 150 to enable features programmed by the co-processor image 154. In certain embodiments, a co-processor image is encrypted, and the license key 330 may provide at least a portion of a decryption key used to decrypt the encrypted co-processor image and to generate the co-processor image 154.

In one embodiment, the module library 310 resides external to computer system 100, such as on a server within a computing cloud. The user application 156 may download a co-processor image 154 from the module library from the server. Alternatively, the co-processor control module 152 may download the co-processor image 154 in response to a request from the user application 156 to program the co-processor image 154 into the configurable co-processor 150. The license key 330 may be acquired permanently and stored within the computer system 100, or the license key 330 may be acquired each time the co-processor image 154 is programmed into the configurable co-processor 150. In alternative embodiments, the module library 310 resides within the computer system 100. For example, the module library 310 may be installed into system disk 114, within the computer system 100, as part of a software support package associated with the configurable co-processor 150.

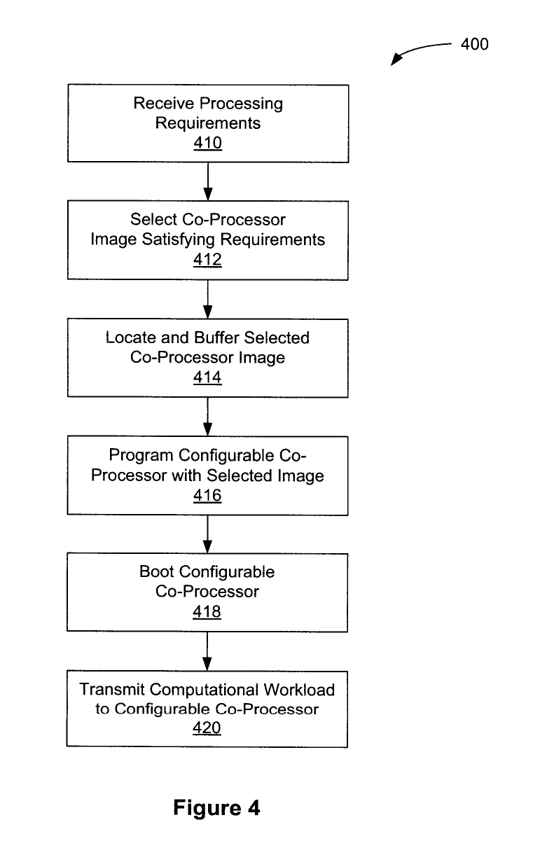

FIG. 4 is a flow diagram of method steps 400 for programming a configurable co-processor, according to one embodiment of the present invention. Although the method steps are described in conjunction with the systems of FIGS. 1-3, persons skilled in the art will understand that any system configured to perform the method steps, in any order, is within the scope of the invention.

The method begins in step 410, where the co-processor control module 152 receives processing requirements from user application 156. The processing requirements may include any technically feasible specification for data processing. For example, the processing requirements may name a specific type or version of a co-processor image, or may generally specify buffer or cache size requirements in conjunction with a processor specification, or may specify a given instruction set architecture. The processing requirements may be represented using any technically feasible technique. In step 412, the co-processor control module 152 selects a co-processor image 154 with characteristics that satisfy the processing requirements.

In step 414, the co-processor control module 152 locates and buffers the selected co-processor image 154. The co-processor image 154 may reside within computer system 100, within a remote server, or within any other technically feasible storage system. The co-processor image 154 may be stored as a file that can be retrieved and buffered within system memory 104. The co-processor image 154 may be generated using any technically feasible technique. In step 416, the co-processor control module 152 programs the configurable co-processor 150 with the co-processor image 154. In one embodiment, the co-processor control module 152 a license key enables the configurable co-processor 150 to be programmed with the co-processor image 154.

In step 418, the co-processor control module 152 boots the configurable co-processor 150. The process of booting may involve a reset cycle, and an implementation-specific boot load chronology. In one embodiment, the configurable co-processor 150 checks a license key to determine whether the co-processor image 154 may be used with the configurable co-processor 150. The method terminates in step 420, where the co-processor control module 152 transits a computational workload to the configurable co-processor 150.

In sum, a technique for programming a configurable co-processor is disclosed. The configurable co-processor includes field programmable logic and is programmed via a co-processor image. Additional programming instructions may be specified for a given processor programmed into the configurable co-processor. The technique involves selecting at least one co-processor image to satisfy processing requirements. The at least one co-processor image is programmed into the configurable co-processor, thereby establishing structure for underlying logic of the configurable co-processor. The configurable co-processor is then booted and begins execution of application-specific programming instructions.

One advantage of the present invention is that application-specific hardware design optimizations may be implemented after hardware for a processing system has been manufactured. Application developers are able to develop new instruction sets or optimize parametrically defined processor systems based on application needs. This is advantageous compared to prior art systems in which all hardware design decisions are frozen prior to manufacture.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the foregoing is directed to embodiments of the present invention, other and further embodiments of the invention may be devised without departing from the basic scope thereof, and the scope thereof is determined by the claims that follow.

What is claimed is:

1. A computer-implemented method for programming a configurable co-processor, the method comprising:
selecting a co-processor image having characteristics that satisfy a specific set of processing requirements and comprising detailed instructions for configuring one or more logic circuits within the configurable co-processor, wherein the configurable co-processor comprises field programmable logic elements, storage elements, and signal routing resources;
storing the co-processor image in a memory;
programming the configurable co-processor based on the co-processor image stored in the memory; and
booting the configurable co-processor.

2. The method of claim 1, further comprising the step of receiving the specified set of processing requirements from a user software application.

3. The method of claim 2, wherein the specified set of processing requirements includes a specification for a processor type, a buffer size and a cache size.

4. The method of claim 2, further comprising the step of transmitting a computational workload generated by the user software application to the configurable co-processor.

5. The method of claim 2, wherein the configurable co-processor is coupled to a processing unit, which is configured to execute the user software application.

6. The method of claim 1, wherein the step of programming the configurable co-processor is enabled by a license key.

7. The method of claim 1, wherein the step of booting the configurable co-processor is enabled by a license key.

8. A computer-readable medium including instructions that, when executed by a processing unit, cause the processing unit to program a configurable co-processor, by performing the steps of:
selecting a co-processor image having characteristics that satisfy a specific set of processing requirements and comprising detailed instructions for configuring one or more logic circuits within the configurable co-processor, wherein the configurable co-processor comprises field programmable logic elements, storage elements, and signal routing resources;
storing the co-processor image in a memory;
programming the configurable co-processor based on the co-processor image stored in the memory; and
booting the configurable co-processor.

9. The computer-readable medium of claim 8, further comprising the step of receiving the specified set of processing requirements from a user software application.

10. The computer-readable medium of claim 9, wherein the specified set of processing requirements includes a specification for a processor type, a buffer size and a cache size.

11. The computer-readable medium of claim 9, further comprising the step of transmitting a computational workload generated by the user software application to the configurable co-processor.

12. The computer-readable medium of claim 9, wherein the configurable co-processor is coupled to the processing unit, which is configured to execute the user software application.

13. The computer-readable medium of claim 8, wherein the step of programming the configurable co-processor is enabled by a license key.

14. The computer-readable medium of claim 8, wherein the step of booting the configurable co-processor is enabled by a license key.

15. A computer system, comprising:
a system memory;
a configurable co-processor;
a processing unit coupled to the system memory and to the configurable co-processor, and configured to:
select a co-processor image having characteristics that satisfy a specific set of processing requirements and comprising detailed instructions for configuring one or more logic circuits within the configurable co-processor, wherein the configurable co-processor comprises field programmable logic elements, storage elements, and signal routing resources;
store the co-processor image in a memory;
program the configurable co-processor based on the co-processor image stored in the memory; and
boot the configurable co-processor.

16. The system of claim 15, wherein the processing unit is further configured to receive the specified set of processing requirements from a user software application.

17. The system of claim 16, wherein the specified set of processing requirements includes a specification for a processor type, a buffer size and a cache size.

18. The method of claim 16, wherein the processing unit is further configured to transmit a computational workload generated by the user software application to the configurable co-processor.

19. The system of claim 15, wherein a license key enables the processing unit to program the configurable co-processor.

20. The system of claim 15, wherein a license key enables the processing unit to program the configurable co-processor.
